(19) United States
(12) Patent Application Publication
(10) Pub. No.: US 2015/0064094 A1
(43) Pub. Date: Mar. 5, 2015

(54) METHOD OF PREPARING TITANIUM CARBIDE POWDER

(71) Applicant: NANO TECH Co., Ltd., Chungcheongbuk-do (KR)

(72) Inventor: Hyun Ho Lee, Chungcheongbuk-do (KR)

(21) Appl. No.: 14/461,432

(22) Filed: Aug. 17, 2014

(30) Foreign Application Priority Data
Aug. 27, 2013 (KR) 10-2013-0101611

(51) Int. Cl. C01B 31/30

(52) U.S. Cl. CPC C01B 31/305
USPC 423/440

(57) ABSTRACT

Disclosed herein is a method for preparing titanium carbide powder. More specifically, the method comprises the steps of: mixing titanium dioxide (TiO₂), calcium (Ca) and carbon (C); heating the resultant mixture to form titanium carbide (TiC) under an inert atmosphere; and washing the reaction mixture with water to separate the titanium carbide from calcium oxide (CaO). The present method is capable of providing titanium carbide powders homogeneous in shape and particle size in a relatively low temperature.

### CROSS-REFERENCE TO RELATED APPLICATION AND CLAIM OF PRIORITY

This application claims the benefit of the Korean Patent Application No. 10-2013-0101611, filed Aug. 27, 2013, at the Korean Intellectual Property Office, the disclosures of which are incorporated herein in their entirety by reference.

### BACKGROUND

1. Field of the Invention

The present invention relates to a method for preparing titanium carbide. More particularly, the present invention relates to a method of preparing ultrafine titanium carbide powder through metallic spheroidization.

2. Discussion of Related Art

Recent years have seen a rapid increase in the use of titanium carbide (TiC), which is known to improve cutting capability, weight reduction and durability when used as material for cutting tools.

The superior cutting capability of titanium carbide is attributable to the high hardness, thermal stability arising from its high melting point (3,065-3,257° C.), low electrical resistance (60-250 μΩcm), and excellent resistance against wear and corrosion. It has been shown that the finer and purer the raw material for titanium carbide becomes, the better its properties improve.

Accordingly, there are ongoing efforts to develop titanium carbide powders ranging in size from tens of nanometers to a few hundred nanometers, which are finer than those currently in use with a size of 1-1.5 micrometers.

Prior art methods for preparing titanium carbide powders generally involved either mixing titanium oxide powder with carbon and heating the mixture under a nitrogen-free, highly pure atmosphere of hydrogen at approximately 2100 to 2300° C., or self-propagation high temperature synthesis (SHS) where titanium tetrachloride (TiCl₄), produced by reacting titanium dioxide with chlorine, is reduced with magnesium or sodium to yield titanium (sponge titanium), which in turn is mixed with carbon. Among these, SHS, in particular, has recently found widespread use since the process affords high purity titanium carbide in an economical fashion.

However, since the SHS process involves a reaction of solid metallic titanium mixed with solid carbon, the heat of reaction can be so high as to cause the temperature to rise almost up to the melting point of titanium carbide, allowing diffusion and growth of the particles produced. This made it virtually impossible to obtain fine powders through the process and necessitated a lengthy grinding step such as ball milling for applications where fine particles of a few micrometers or less were required: a laborious work due to the high hardness of TiC powder.

To address this problem, attempts have been made to lower the reaction temperature of 3210° C. to 1500° C., the diffusion temperature of titanium carbide, by adding transition metal such as nickel as a coolant during the SHS reaction to exploit the latent heat of melting of the transition metal. The problem with this approach is that it requires adding 30% or more of transition metal and dissolving the excess metal with acid after the reaction.

Although the brittle TiC lends itself well to milling, the aforementioned approach of ball milling coarse TiC powders obtained by the SHS process still suffers from an increase in the impurities during the milling step since TiC is even harder than the ultrahard material (WC) used for the ball mill.

Other methods such as sol-gel process or mechanical alloying have also been proposed. These methods, however, are prone to either contamination by impurities or difficulties in terms of controlling reaction variables, and thus, are inadequate for large scale production of powders.

To address this problem, Korean registered patent No. 0546040 has suggested a method for producing titanium carbide powder by mixing titanium dihydride with carbon. The scarcity of the starting material titanium dihydride, however, drives up the cost of production, making its commercial application difficult.

### SUMMARY OF THE INVENTION

It is an object of the present invention to provide a method for preparing titanium carbide at a relatively low temperature.

It is another object of the present invention to provide a facile method for preparing titanium carbide in a large scale using simple processes.

It is still another object of the present invention to provide a method for preparing titanium carbide in a large scale.

It is a still another object of the present invention to provide a method for preparing titanium carbide with a uniform shape and particle size.

It is yet another object of the present invention to provide a method for preparing titanium carbide in an ultrafine form.

In order to achieve the above-mentioned objects, the present invention provides a method for preparing titanium carbide powder, the method comprising the steps of: mixing titanium dioxide (TiO₂), calcium (Ca) and carbon (C); heating the resultant mixture to form titanium carbide (TiC) under an inert atmosphere; and washing the mixture with water to separate titanium carbide from calcium oxide (CaO).

In an embodiment of the present invention, titanium oxide and calcium are preferably mixed at a ratio of from more than 2 moles to 6 moles or less of calcium per each mole of titanium dioxide.

In an embodiment of the present invention, the ratio of mixing is preferably from 1 mole to 5 moles of carbon per each mole of titanium dioxide.

According to another embodiment of the invention, the mixing step can be conducted under an inert atmosphere.

According to yet another embodiment of the invention, the mixing step can be conducted as a dry mixing.

In an embodiment of the present invention, the heating step can be conducted at a maximum temperature of from 600° C. to 1500° C. More preferably, the heating step can conducted at a temperature above the melting point of calcium.

According to another embodiment of the invention, the heating step can be conducted after the mixture is placed in a carbonaceous container.

According to yet another embodiment of the invention, the heating step can be conducted after the mixture is compression molded.

In an embodiment of the invention, the washing step with water preferably comprises dissolving calcium oxide out of the mixture with titanium carbide in water.

In another embodiment of the invention, the particle size of the prepared titanium carbide powder ranges from 10 nm to 1 μm.

In yet another embodiment of the invention, the washed titanium carbide can be further treated with acid if need be.

### BRIEF DESCRIPTION OF THE DRAWINGS

FIG. 1 is a graph showing X-ray diffraction analysis of the titanium carbide powder and CaO, a byproduct, from Examples 1 and 3 before washing with water.

FIG. 2 is a field emission scanning electron microscopy (FE-SEM) photograph of the titanium carbide powder and CaO, a byproduct, from Examples 1 and 3 before washing with water.

FIG. 3 is a graph showing X-ray diffraction analysis of the titanium carbide powder from Example 1.

FIG. 4 is an FE-SEM photograph of the titanium carbide powder from Example 1.

### DETAILED DESCRIPTION

Certain embodiments of the inventive method for preparing titanium carbide powder are explained in detail below.

It should be noted beforehand that the interpretation of the terms and words used in the present specification and/or claims should not be limited to their conventional or dictionary meaning, but should be interpreted according to the principle that the inventor is entitled to be his own lexicographer for the purpose of defining his invention in the best way possible, in accordance with the technical idea of the present invention.

In the beginning, titanium dioxide (TiO₂), calcium (Ca) and carbon (C) are mixed.

Both anatase and rutile crystal forms of titanium dioxide can be used, with the anatase form being preferred due to its ease of reaction. In addition, it is preferred that titanium dioxide powder with the smallest particle size as possible is selected since this helps the product titanium carbide to achieve an ultrafine particle size. The smaller the size of titanium dioxide gets, the finer the particle size of the titanium carbide becomes.

Calcium allows titanium to react with carbon by reducing titanium dioxide. In a specific embodiment, the mixing ratio of titanium dioxide and calcium is preferably from more than 2 moles to 6 moles or less of calcium per each mole of titanium dioxide. If calcium is present in less than 2 moles, some of titanium dioxide can remain unreacted. If more than 6 moles of calcium is present, a local excess of calcium can form around titanium, and this leads to the formation of coarse particles and coagulation of powder, making it difficult to obtain a homogeneous powder. In theory, 2 moles of calcium per each mole of titanium dioxide should be sufficient for the entire titanium dioxide to react, but in practice an amount of calcium in excess of the theoretical amount is preferably used since due to its high reactivity, some of the calcium will be lost to unwanted oxidation.

The reactivity of calcium increases as its particle size decreases, making its handling cumbersome. Thus, use of calcium powder with somewhat larger particle size than that of TiO₂ is advisable.

Carbon is the source of the carbide moiety of titanium carbide. Any substance known as carbon source in the field can be used without limitation. For instance, activated carbon and carbon black may be used. When the particle size of the titanium carbide produced is taken into consideration, carbon black is preferred.

In a specific embodiment, the mixing ratio of titanium dioxide and carbon is preferably from 1 mole to 5 moles of carbon per each mole of titanium dioxide. If carbon is present in less than 1 mole, some of titanium dioxide can remain unreacted and unwanted titanium carbide such as Ti₈C₅ may form. If more than 5 moles of carbon is present, the excess carbon hinders the contact between titanium dioxide and calcium, interfering with the reduction of titanium.

As is the case with calcium, carbon powder that is too coarse might cause mixing problems and it is preferable to select a particle size less than that of calcium.

As mentioned above, the mixing step is preferably conducted under an inert atmosphere to prevent calcium from being oxidized.

The mixing step can be either wet or dry. That being said, dry mixing can be better in terms of controlling calcium oxidation since it is difficult to achieve that in wet mixing.

The mixing time is not particularly limited as long as there is enough time for the starting materials to thoroughly mix, and a wide range of variations can be made to the mixing time in consideration of factors such as the particle sizes of the starting materials and the method of mixing. For example, the mixing can take place for, but is not limited to, from 10 minutes to 48 hours.

In the next step, the resultant mixture is heated under an inert atmosphere to form titanium carbide. The heating step forms titanium carbide by providing a reactive atmosphere for each starting material. The chemical reaction for forming titanium carbide is given below:

[chemical formula]

TiO₂+χCa+C→TiC+χCaO

In the heating step, the temperature is raised at an appropriate rate up to a point at which the above reaction effectively proceeds. Then the reaction is allowed to proceed for a sufficient amount of time at this target temperature, the maximum of which is preferably from 600° C. to 1500° C. to afford a high yield for titanium carbide.

More preferably, the maximum temperature is equal to or higher than the melting point of calcium; in other words, from calcium's melting point to 1500° C. If the reaction is run above the melting point of calcium, then calcium is present in a liquid state and the increased fluidity significantly improves mass distribution in the reaction system. The improved mass distribution in turn leads to homogeneous and spheroidized titanium carbide.

The container for the reaction mixture during the heating step is not particularly limited provided it is made out of a material capable of withstanding the reaction temperature. In a specific embodiment, carbonaceous containers are preferred, since they can avoid contamination of the powder from local reaction induced by the heat of the reaction as may be seen in glass or ceramic containers.

The reaction mixture can be compression molded before the heating step, if necessary. Compression molding of the reaction mixture raises the reaction efficiency by expanding the contact area of the particles.

In the next stage, washing with water is performed to separate the titanium carbide and calcium oxide (CaO). Calcium oxide is formed as a byproduct of the reaction in the present invention. Since calcium oxide readily dissolves in water, a simple washing step with water is able to remove it. Thus, the present invention is capable of providing high purity titanium carbide with ease due to its simple and facile byproduct removal as explained above.

The present invention can further comprise the step of acid treating the titanium carbide washed with water. Minute quantities of impurities present after washing with water can be removed with such acids as sulfuric acid, nitric acid, hydrochloric acid and acetic acid to afford a high purity titanium carbide product.

The particle size of the titanium carbide powder prepared according to the present invention as set forth above ranges from 10 nm to 1 μm, preferably, 10 nm to 500 nm, providing titanium carbide in an ultrafine form.

The inventive method for preparing titanium carbide powder can afford easy control of coagulation of the powder due to its relatively low reaction temperature.

The inventive method for preparing titanium carbide powder achieves a facile mass distribution brought about by the calcium reductant, enabling an overall homogeneous reaction control.

The inventive method for preparing titanium carbide powder boasts a low production cost since it utilizes the ubiquitous materials of titanium dioxide and calcium.

The inventive method for preparing titanium carbide powder also lends itself advantageously to commercial production since it is capable of providing in a large scale, titanium carbide with a uniform shape and particle size distribution.

Certain embodiments of the invention are illustrated by the following non-limiting examples. The following examples further illustrate the invention, but they should not be construed as in any way limiting the scope of the attached claims. It will be readily apparent to those of ordinary skill in the art that without departing from the scope or technical idea of the present invention, various changes and modifications may be made to the examples below and that these changes and modifications also fall under the scope of the attached claims.

### Example 1

9 moles of anatase TiO₂, 23.4 moles of calcium and 9.0 moles of carbon were provided, with each material having a purity of at least 99%. All materials were mixed dry for 3 hours under an argon gas-filled atmosphere to prevent the oxidation of calcium during mixing.

After the mixing was over, the powder was compression molded with a press under a pressure of at least 1350 kgf/mm², and the molded mixture was moved into an electric furnace via a carbonaceous crucible. In advance of heating this mixture in the electric furnace, vacuum was applied and a flow of argon gas was let in, with the argon atmosphere being maintained throughout the experiment. The heating rate of the electrical furnace was 5° C./min with the peak temperature set at 850° C.

The reaction mixture was allowed to react for an hour at the peak temperature and when the reaction was over, it was washed five times with distilled water. The washed mixture underwent the final impurity removal step with dilute hydrochloric acid to ultimately yield a TiC powder. This powder was found to be pure TiC with a particle size of 300 nm or less by X-ray diffraction (XRD) and field emission scanning electron microscopy (FE-SEM) analysis.

### Example 2

4.5 moles of anatase TiO₂, 11.7 moles of calcium and 5.0 moles of carbon were provided, with each material having a purity of at least 99%. All materials were wet mixed for 30 minutes and argon gas was filled into the mixing container to prevent the oxidation of calcium during mixing.

After the mixing was over, the powder was compression molded with a press under a pressure of at least 1150 kgf/mm², and the molded mixture was moved into an electric furnace via a carbonaceous crucible. In advance of heating this mixture in the electric furnace, vacuum was applied and a high vacuum condition being maintained throughout the experiment. The heating rate of the electrical furnace was 5° C./min with the peak temperature set at 880° C.

The reaction mixture was allowed to react for 2 hours at the peak temperature and when the reaction was over, it was washed seven times with distilled water. The washed mixture underwent the final impurity removal step with dilute hydrochloric acid to ultimately yield a TiC powder. This powder was found to be pure TiC with a particle size of 250 nm or less by XRD and FE-SEM analysis.

### Example 3

The same procedure as Example 1 was repeated except for the fact that 28.8 moles calcium was used instead. The resultant powder was found to be pure TiC with a particle size of 370 nm or less by XRD and FE-SEM analysis.

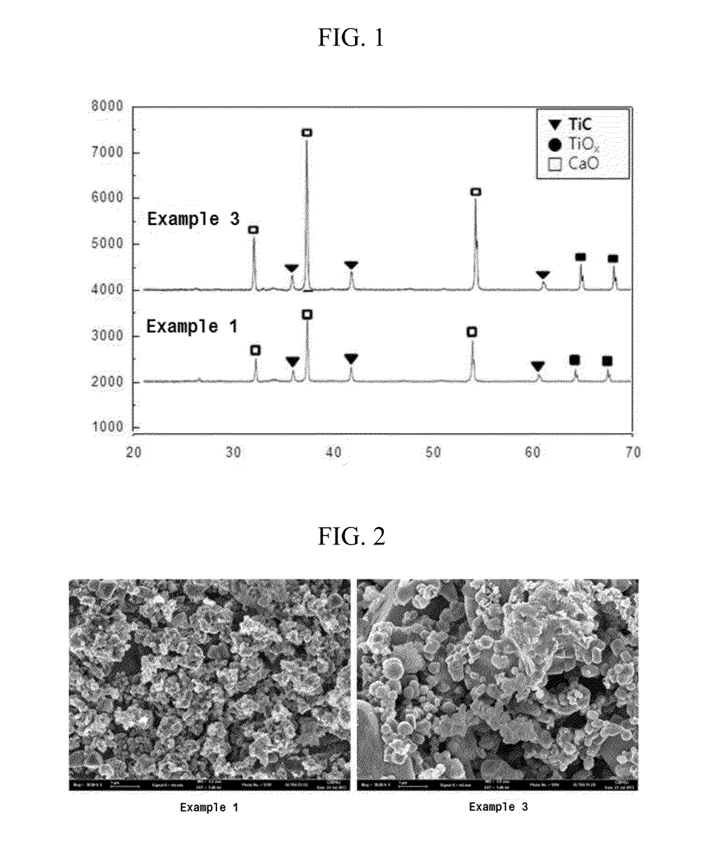

For reference, the XRD graph and FE-SEM photograph for the TiC powder in mixture with CaO from Examples 1 and 3 are presented in FIGS. 1 and 2, respectively.

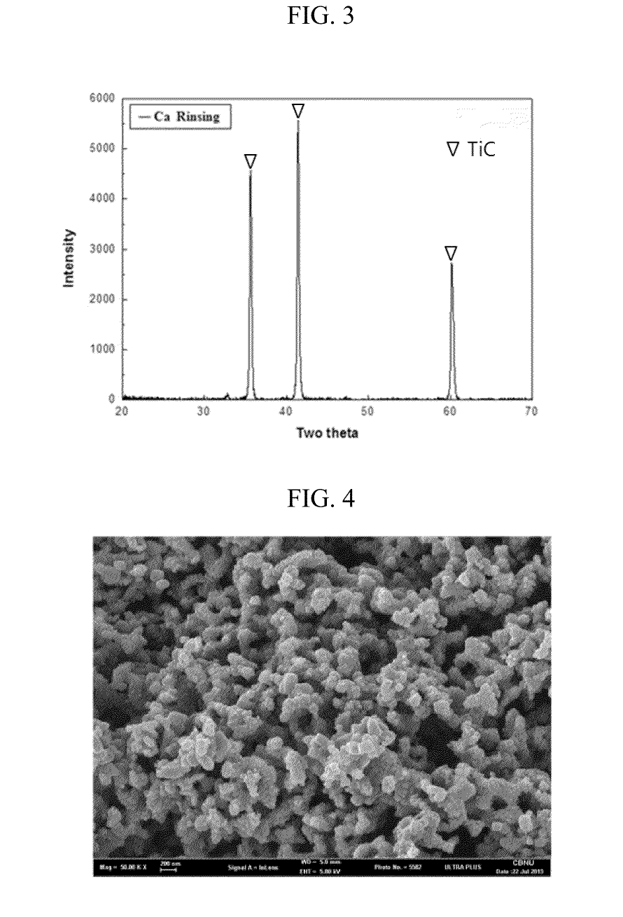

Referring to FIGS. 1 and 2, it can be seen that the shape of TiC particles change according to the calcium content. FIGS. 3 and 4 respectively represent the XRD graph and FE-SEM photograph for the TiC powder prepared according to Example 1.

Although the foregoing invention has been described in some detail by way of specific embodiments and drawings, by no means is the present invention limited thereto. Those skilled in the art may recognize various changes, modifications and other equivalents to the specific embodiments described herein without departing from the technical idea or the claims attached hereto.

What is claimed is:

1. A method for preparing titanium carbide powder, the method comprising the steps of:
mixing titanium dioxide (TiO₂), calcium (Ca) and carbon (C);
heating the resultant mixture to form titanium carbide (TiC) under an inert atmosphere; and
washing the mixture with water to separate titanium carbide from calcium oxide (CaO).

2. The method of claim 1, wherein the mixing ratio between titanium dioxide and calcium is from more than 2 moles to 6 moles or less of calcium per each mole of titanium dioxide.

3. The method of claim 1, wherein the mixing ratio between titanium dioxide and carbon is from 1 mole to 5 moles of carbon per each mole of titanium dioxide.

4. The method of claim 1, wherein the mixing step is carried out under an inert atmosphere.

5. The method of claim 1, wherein the mixing step is carried out as a dry mixing.

6. The method of claim 1, wherein the heating step is carried out at a maximum temperature of from 600° C. to 1500° C.

7. The method of claim 1, wherein the heating step is carried out at a temperature above the melting point of calcium.

8. The method of claim 1, wherein the heating step is carried out after the mixture is placed in a carbonaceous container.

9. The method of claim 1, wherein the heating step is carried out after the mixture is compression molded.

10. The method of claim 1, wherein the washing step comprises dissolving calcium oxide out of its mixture with titanium carbide in water.

11. The method of claim 1, wherein the particle size of the prepared titanium carbide powder ranges from 10 nm to 1 μm.

12. The method of claim 1, further comprising acid treating the titanium carbide washed with water.
